(19) United States
(12) Patent Application Publication
(10) Pub. No.: US 2006/0004923 A1
(43) Pub. Date: Jan. 5, 2006

(54) System and method for using portals by mobile devices in a disconnected mode

(76) Inventors: Norman Howard Cohen, Suffern, NY (US); Stefan Hepper, Tuebingen (DE); Veronique Perret, Tarrytown, NY (US); Apratim Purakayastha, Yorktown Heights, NY (US); Thomas Schaeck, Achern (DE)

Correspondence Address: IBM CORPORATION;INTELLECTUAL PROPERTY LAW, 11400 BURNET ROAD, AUSTIN, TX, 78758, US

(21) Appl. No.: 10/531,055

(22) PCT Filed: Oct. 15, 2003
(86) PCT No.: PCT/EP03/11395

§ 371 Date: Apr. 12, 2005

(30) Foreign Application Priority Data
Nov. 2, 2002 (EP) 02024364.8

(51) Int. Cl. G06F 15/16

(52) U.S. Cl. 709/228; 709/219

(57) ABSTRACT

The present invention provides a method and system for allowing use of a Portal by Mobile Devices in a disconnected mode. The inventive system and method provide means to automatically create a Mobile Device specific content topology at the server side based on an existing user-defined connected content topology, user selectable options as well as dynamically changeable technical parameters, e.g. bandwidth, time, location, type of the target Mobile Device, downloads this Mobile Device specific content topology including its associated data to a target Mobile Device, and uses that Mobile Device specific content topology with its data by a local disconnected Portal frame work of a target Mobile Device in a disconnected mode. The Mobile Device specific content topology will be updated by a synchronization mechanism during connecting mode.

### BACKGROUND OF THE INVENTION

Field of the Invention

The present invention relates generally to mobile communications, and more particularly relates to a system and method for using Portals by Mobile Devices in a disconnected mode.

A variety of Mobile Devices exist, e.g. Mobile Phones, Personal Digital Assistants, Notebooks. More and more these Mobile Devices are used to access Web Content from Portals. A Portal in the present invention may be defined as an application which provides a secure, single point of interaction with diverse information, business processes, and people, personalized to a user's needs and responsibility. Typically, Portals get information from local or remote data sources, e.g. from Databases, transaction systems, syndicated content providers, or remote web sites, and render and aggregate this information into complex pages to provide information to users in a condensed form. In addition to pure information, many Portals also include applications like e-mail, calendar, organizers, banking, bill presentment, etc. A well-known example is the Yahoo! Portal that provides access to a large amount of content and applications.

Different rendering and selection mechanisms are required for different kinds of information or applications, but all of them rely on the Portal's infrastructure and operate on data or resources that are owned by the portal, e.g. user profile information, persistent storage or access to managed content. Consequently, most of today's Portal implementations provide a component model, where pluggable Portal components modules referred to as Portlets can be added to the Portal infrastructure. Portlets are pluggable components that can be added to Portals and are designed to run inside a Portal's Portlet container. Portlets may provide different functions ranging from simple rendering of static or dynamic content to application functions such as e-mail, calendar, etc. Portlets are invoked indirectly via the Portal application and produce content that is suited for aggregation in larger pages, e.g. Portlets should produce mark-up fragments adhering guidelines that assure that the content generated by different Portlets can be aggregated into one page. Typically, Portlets run on the Portal server, processing input data and rendering content locally. Often, the content for Portlets which are displayed very often is cached locally to improve response times, performance and scalability of Portals.

Mobile Devices having a wired connection to the Portal commonly use a TCP/IP and HTTP protocol for accessing Web Content from the Portal. Mobile Devices having wireless communication like Mobile phones or personal assistants use a WAP protocol (Wireless Application Protocol) with a WAP gateway. Between WAP gateway and the HTTP-server on which the Portal may be installed TCP/IP and HTTP is used.

The Web Content rendered from the Portal may be stored locally in the Mobile Device and can be viewed later when the connection to the net is no longer available. These solutions are based either on displaying static markup pages (e.g. AvantGo), or are data bases for Mobile Devices with a graphical user front end (e.g. Mobile Notes).

U.S. Pat. No. 6,421,717 discloses a method and system for enabling Web Content to be loaded on Mobile Devices, and for users of Mobile Devices to operate with such web content on their Mobile Devices in an interactive manner while in a disconnected mode.

This patent mainly describes the model of replication of Web content to the Mobile Device for disconnected offline-browsing. This offline-browsing is mainly based on static content and only simple forms may be filled out in a disconnected-mode. It does not support complete applications that may interact with each other at the Mobile Device side. In addition the content replication is based on the user interest and not on technical parameters like bandwidth, costs, location.

It is therefore object of the present invention to provide an expanded communication architecture between Mobile Devices and Portal allowing use of the Portal in disconnected mode without the restrictions and disadvantages of the prior art solutions.

This object is solved by the features of the independent claims.

Further advantageous preferred embodiments of the present invention are laid down in the dependent claims.

### SUMMARY OF THE INVENTION

The present invention provides a method and system for allowing use of a Portal by Mobile Devices in a disconnected mode. The inventive system and method provide means to automatically create a Mobile Device specific content topology at the server side based on an existing user-defined connected content topology, user selectable options as well as dynamically changeable technical parameters, e.g. bandwidth, time, location, type of the target Mobile Device, downloads this Mobile Device specific content topology including its associated data to a target Mobile Device, and uses that Mobile Device specific content topology with its data by a local disconnected Portal frame work of a target Mobile Device in a disconnected mode. The Mobile Device specific content topology will be updated by a synchronization mechanism during connected mode.

These and additional features and advantages of the present invention will become more apparent from the detailed description set forth below when taken in conjunction with the drawings.

### BRIEF DESCRIPTION OF THE FIGURES

The accompanying drawings, which are incorporated herein and form part of the specification, illustrate embodiments of the present invention and, together with the description, further serve to explain the principles of the embodiments of the invention.

FIG. 1 shows an example of an IBM Portal page with its Portal specific content topology,

FIG. 2 shows an example of a prior art communication process between Mobile Device and Portal,

FIG. 3 shows a basic implementation of the present invention,

FIG. 4 shows a diagram for using the inventive architecture as shown in FIG. 3,

FIG. 5 shows a content topology as used by the present invention,

FIG. 6 shows a more detailed process flow for creating a Mobile Device specific content as used by the present invention,

FIG. 7 shows a preferred architecture using the present invention as shown in FIG. 3,

FIG. 8 shows an example how a Portlet may be programmed,

FIG. 9 shows how disconnected Portlets are sent to the target Mobile Device,

FIG. 10 A-D show the screens to create a new user profile according to the present invention,

FIG. 11 A-D show the screens to switch between connected and disconnected mode, and

FIG. 12 A-E show preferred embodiments of the replication process as used by the present invention.

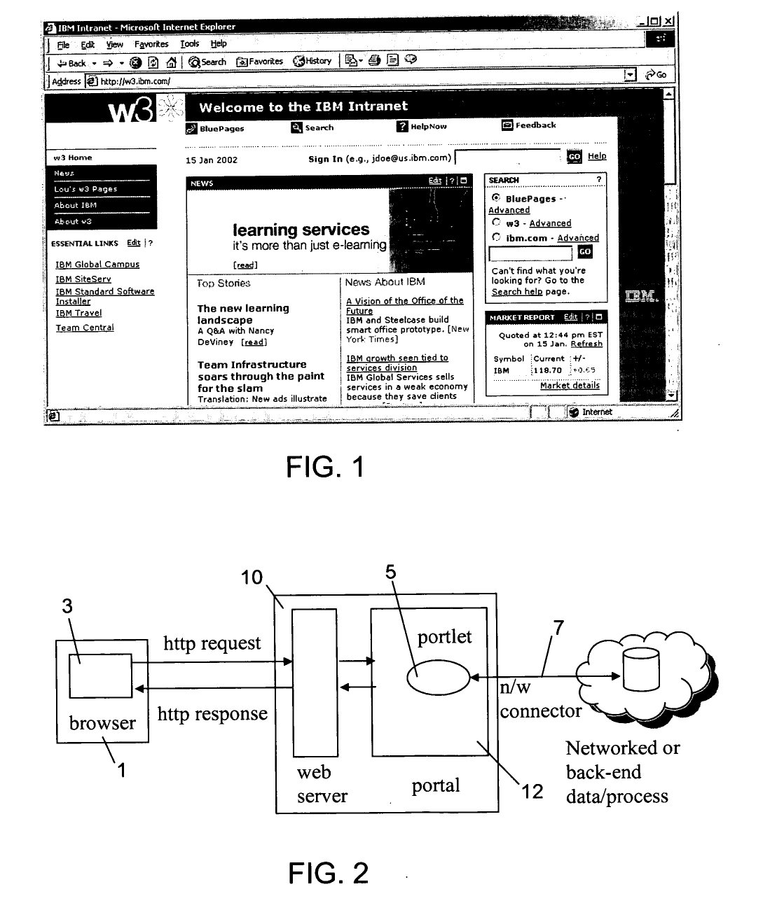

Today there exist a number of frameworks which provide the functionality of a Portal to a customer. The base functionality of a Portal includes the ability for the end-user to compile his personal web page from a set of smaller information units called “Portlets”. FIG. 1 shows as an example of an IBM Intranet Portal page with the search, market report, news Portlets. The Portal aggregates these Portlets into a Portal page according to a given page layout and design or a so called “content topology”. The content topology is represented by an internal tree structure representing the Portal page layout. Each node in the tree is represented by some kind of layout element like column or row. Each leaf in the tree is represented by a Portlet which is called to generate its specific markup/content. The Portal page is generated in sequence following the numbers shown in tree.

FIG. 2 shows a high-level view of a Portal 12 at the server side 10 and how Portlets 5 displays their content to the Mobile Device 1 today. The browser 3 of the Mobile Device 1 requests a portal page consisting of several Portlets 5. The Portlets 5 typically access data using network/back-end connectors 7 such as Web-Services or Lotus Notes. They generate markup fragments which are returned as Portlet response. Typically, several Portlet responses are aggregated by the Portal's aggregation component and returned as response to the Mobile Device browser 3.

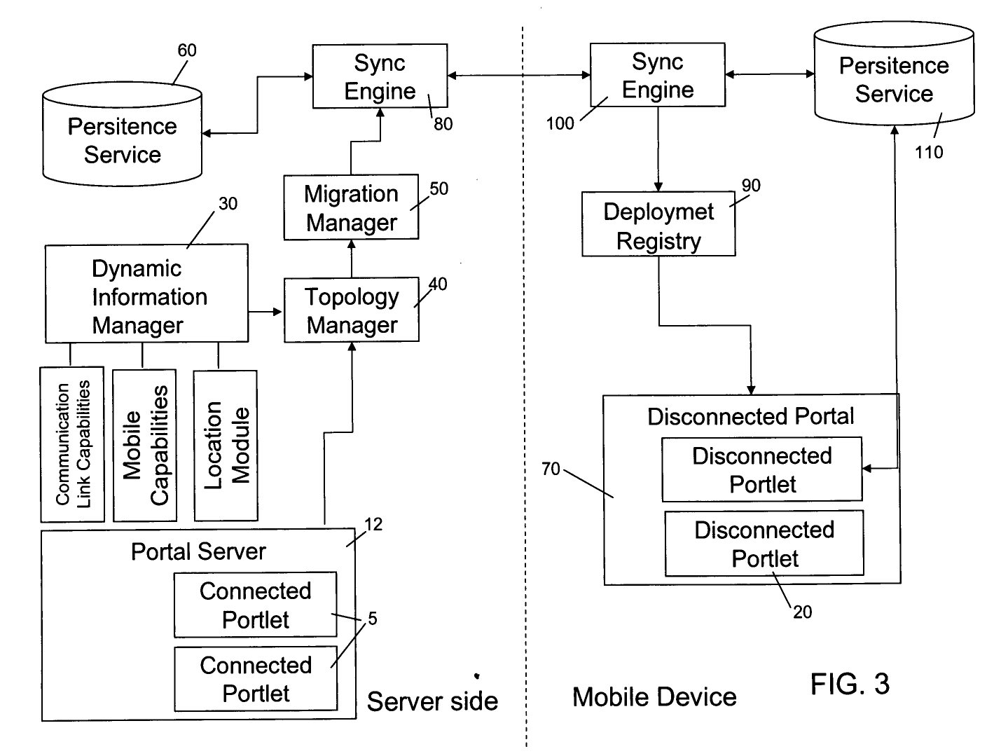

FIG. 3 shows a prior art Mobile Device-Portal server architecture as shown in FIG. 1 extended by the basic components of the present invention.

At the server side 10 of the Portal a Topology Manager 40, a Migration Manager 50, a Synchronization Engine 80, and a Dynamic Information Manager 30 is needed to support disconnected Portals 70. The Topology Manger 40 provides means to create Mobile Device specific content topology for the disconnected Portal 70. Based on an existing user-defined connected content topology, the Topology Manager modifies that existing user-defined connected content topology based on user selected Portlet applications and dynamic information provided by the Dynamic Information Manager. The Migration Manager 50 provides means to package the content topology for the disconnected Portal 70, all needed disconnected Portlet applications (e.g. WAR files), and the data to be rendered by these Portlet applications (Portlet data). Furthermore, the Migration Manager may have the functionality to compress the data to be transferred to the Mobile Device. The Synchronization Engine provides means to exchange data between Server 10 and Mobile Device 1. Finally, the Dynamic Information Manager 30 provides means to support the Topology Manager 40 with dynamic information to optimise the Mobile Device specific content topology created for the Mobile Device 1 by using channel capabilities, Mobile Device capabilities and Mobile Device location information.

At the Mobile Device side 1 a disconnected Portal 70, disconnected Portlets 20, a Deployment Registry 90, a Synchronization Engine 100, and a Database are needed 110.

Disconnected Portal 70 provides means to run on a Mobile Device 1 and to enable users to continue using their Portals in spite of degradation in network connectivity and disconnection.

Disconnected Portlets 20 are light-weight versions of the connected Portlets and they are optimised for the reduced Mobile Device—runtime environment.

The Deployment Registry 90 provides means to deploy and to register the disconnected Portlets 20 received from the Portal server.

The Synchronization Engine 100 provides means to receive the disconnected Portlet applications 20, the Mobile Device specific content topology and to send and to receive the Portlet data.

The Database 110 stores Mobile Device specific content topology and the data to be rendered by the Portlet applications (e.g. DB2e).

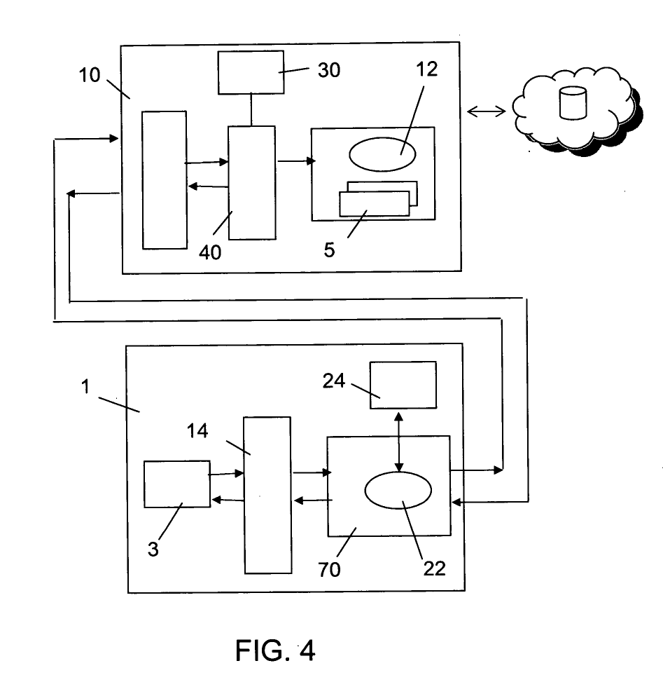

FIG. 4 shows a diagram for using the inventive architecture as shown in FIG. 3. In disconnected mode or offline mode requests from the Mobile Device browser 3 are serviced by a local, scaled down server infrastructure comprising for example an on-device HTTP Web—Server 14, a disconnected Portal 70, disconnected Portlets 22, and a database 24 for Mobile Device specific content topology and data to be rendered by the disconnected Portlets 24.

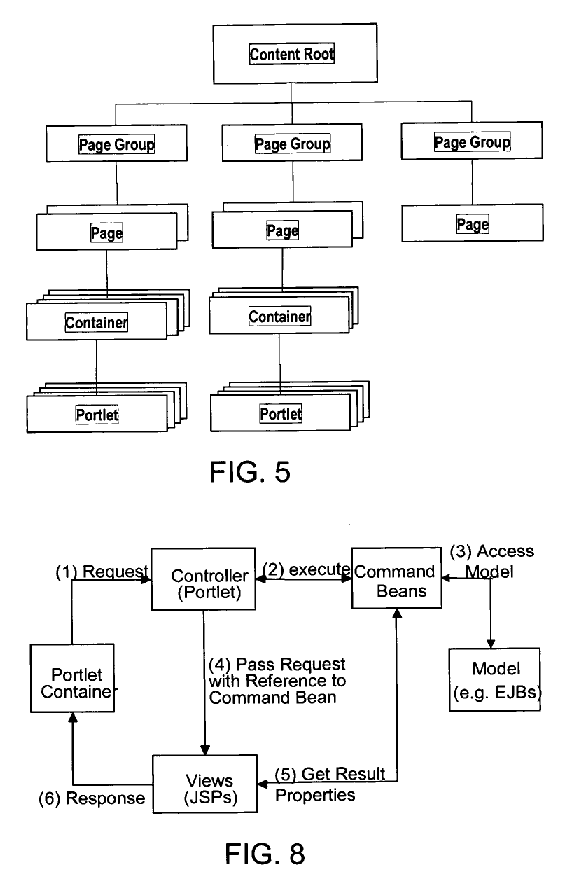

When running the Mobile Device 1 without network access (offline/disconnected) it uses its disconnected Portal 70 to execute the intelligence and display of the data. The data may be static HTML pages, disconnected Portlets 22, Servlets, or JSPs. For rendering purposes the Portlet data is organized in a tree structure with a root frame, different pages, and different Portlets per page (see FIG. 5). That tree structure represents the Mobile Device specific content topology and is stored in a persistence data store 24.

When running the Mobile Device 1 with network access (online/connected mode) the Topology Manager 40 located at the server side 10 may automatically create a Mobile Device specific content topology to be used by Mobile Devices 1 in disconnected mode. The Mobile Device specific content topology is computed at the server side during the online/replication process by using dynamic information provided by the Dynamic Information Manager 30, e.g. communication link capabilities, Mobile Device capabilities parameters and Mobile Device location information.

For example the Mobile Device specific content topology may be generated by the following steps:
the user decides to use his Mobile Device disconnected (e.g. clicks some “go-disconnect” button) and he may select a set of Portlets he wants to replicate to his Mobile Device,
based on the dynamic information provided by the Dynamic Information Manager 30, the Topology Manager 40 generates a Mobile Device specific content topology for a specific user and a specific Mobile Device 1 at its Portal server,
then, the Mobile Device specific content topology is replicated to the Mobile Device 1 by using the Synchronization Engine at the Mobile Device side. This applies accordingly to the disconnected Portlets 5 being selected and their associated Portlet data,
the disconnected Portal 12 can now access this Mobile Device specific content topology and render the content in a browser according to this topology.

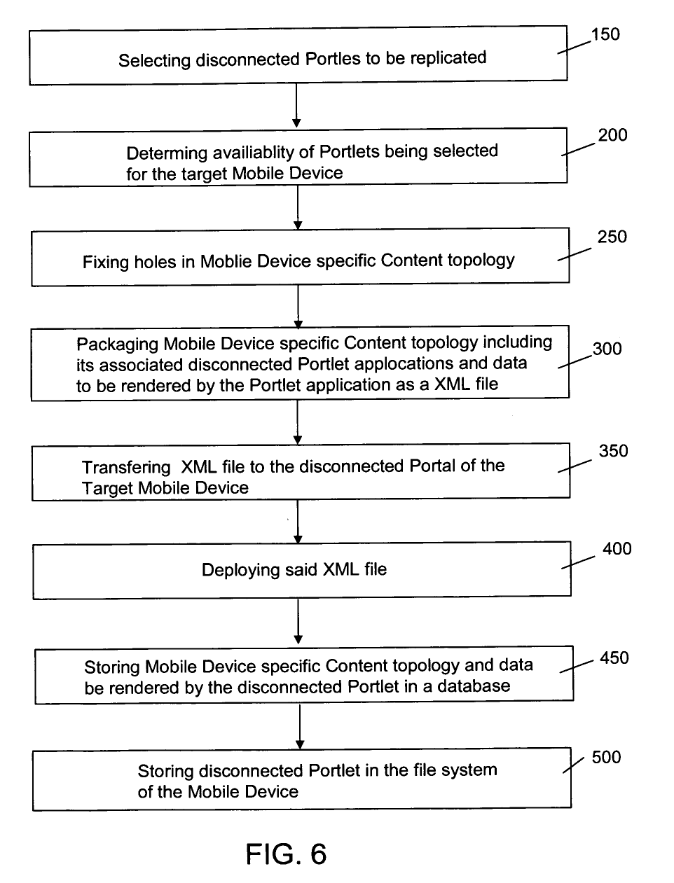

FIG. 6 shows a more detailed process flow for creating a Mobile Device specific content topology as applied by the present invention.

As already explained the present invention automatically creates a Mobile Device specific content topology. The topology is computed at the server side during the replication process by the Topology Manager using dynamic information such as the set of Portlets to replicate, the existing user-defined content topology (server side layout of the content), and the target device capabilities provided by the Dynamic Information Manager.

The Dynamic Information Manager may apply following rules for providing dynamic information to the Topology Manager which creates the Mobile Device specific content topology:
Server side layout defined by the user (existing user-defined connected content topology)
Mobile Device characteristics, e.g. don't replicate Portlets that displays a lot of data onto devices with small screens,
Mobile Device capabilities, e.g. don't replicate portlets that can't render WML onto a device with only a WML browser,
location-based characteristic, e.g. replicate different Portlets when going disconnected at home or at work,
Device-type based characteristic, e.g. replicate the traffic announcement Portlet to my car, but not my laptop,
time-based characteristics, e.g. replicate the Portlet showing the menu of the cafeteria at work in the morning on working days only,
bandwidth based characteristics, depending on the actual available bandwidth and/or transmission costs data may or may not be replicated onto the device. E.g. when having a low bandwidth or transmission costs are very high (i.e. during the day) only Portlets with small data amounts are sent to the device, whereas when having high bandwidth and/or low transmission costs (i.e. during the night) Portlets requiring large amounts of data could be sent to the device.

Typically, the Mobile Device specific content topology is represented by a large amount of data in a Database consisting of Page Groups, Pages, Navigation Paths between pages, Page Layouts, Portlet Instances associates with certain locations in Page Layouts etc (see FIG. 5).

These resources partially may be user specific and partially may be shared across users, with an access control mechanism controlling which entities in the data model are accessible for which users.

Under these assumptions, the process of determining the Mobile Device specific content topology may be preferably designed in the following way:
for each Portlet being selected by the user 150, the Portal makes queries to the Database to determine the Portlet that are accessible to the disconnecting user and are disconnectable 200,
if necessary, the Portal performs a consolidation step to fix “holes” in the Mobile Device specific Content topology resulting from non-disconnectable resources or from Portlets that the user did not select 250. This can either be done by just omitting the Portlets removed form the topology, and therefore changing the layout from the connected layout, or by displaying a static placeholder for the omitted Portlets, to keep the layout the same as in the connected case 2,
the Portal packages and converts the Mobile Device specific content topology including its associated disconnected Portlet application and data to be rendered by the disconnected Portlet applications into an XML document that describes its structure 300. This could be achieved by transforming the object model using a DOM parser and a grammar for the XML-file to create the XML document,
the XML document is transferred to the disconnected Portal of the Mobile Device using a synchronization protocol like SyncML 350,
the disconnected Portal reconstructs the Mobile Device specific content topology from the XML document by pulling the files (WAR files) for any referenced Portlet from the server, deploying the container disconnected Portlets locally 400, and synchronizing the data associated with the referenced Portlets with the server using a synchronization protocol like SyncML,
the Mobile Device specific content topology and the data to be rendered by the disconnected Portlet applications are stored in the Mobile Device's Database 450
the disconnected Portlet applications are stored in the Mobile Device file system 500.

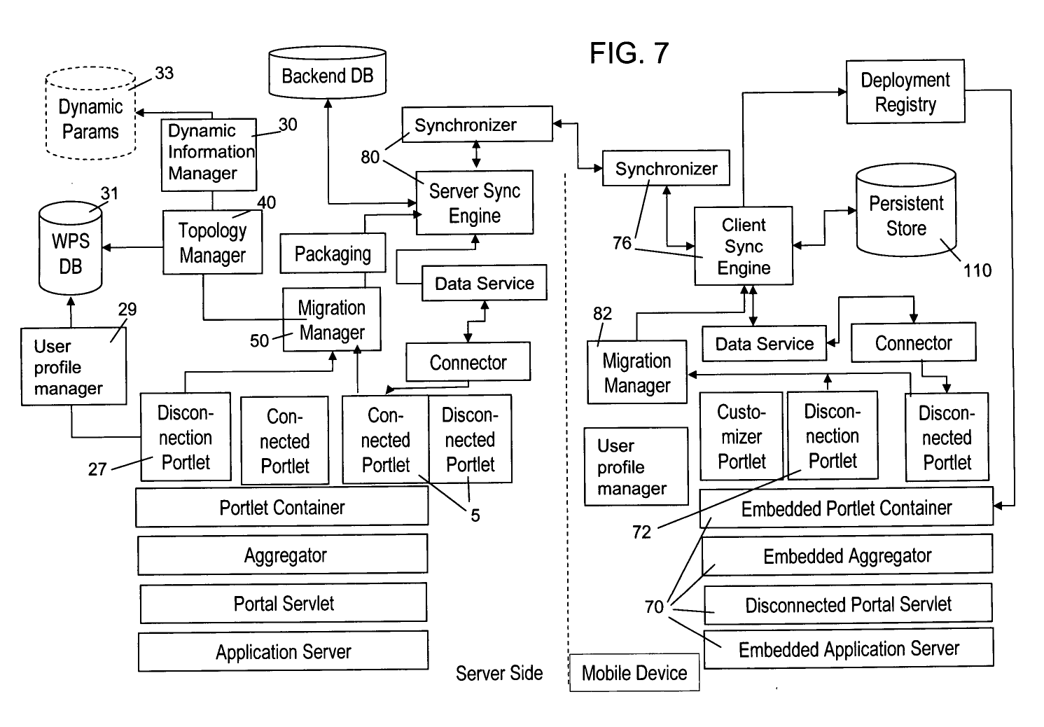

FIG. 7 shows a preferred embodiment of a Portal Server—Mobile Device architecture using the present invention as shown in FIG. 3.

Following components are used at the server side:
a disconnection Portlet 27 which provides means to allow the user to go disconnected; this may also be done automatically based on parameters like time, connection costs, indication that the connection will be lost soon
connected Portlets 5 with their assigned disconnected Portlets designed for running on Mobile Devices,
a user profile which stores information for disconnection. The user profile is managed by a user profile Manager 29 which may additionally provide graphical user interfaces allowing creation of user-defined disconnected profile. The user profile is stored in a Database (31; WPS DB) and is accessed by the Topology Manager 30,
a Migration Manager 50 which provides means to integrate changes from the disconnected Portal with changes that may have occurred in the meantime on the Portal server side; in addition the Migration Manager is also responsible for creating the files to be sent to the target Mobile Device,
a Topology Manger 30 which provides means to create Mobile Device specific content topology for the disconnected Portal based on information from Databases 31,33,
a synchronization server and a Synchronization Engine 80 to synchronize the data between the server disconnected Portlets and the Mobile Device disconnected Portlets.

Following components are used on the Mobile Device side:
a disconnection Mobile Device Portlet 72 to request to go again disconnected,
a disconnected Portal framework 70 consisting of a disconnected Portal Servlet, an embedded aggregator, and an embedded Portlet container which are all tailored towards the requirements of the Mobile Device environment (e.g. only one user, small footprint, restricted Java run-time system),
a Mobile Device synchronization synchronizer and Synchronization Engine 76,
an embedded Application Server 70,
a persistent store 110 to store the data to be rendered by the disconnected Portlet applications (e.g. DB2 e),
a Migration Manager 82 to keep track of the changes made to the persistent store and to trigger the synchronization,
disconnected Portlets 20 rendering the output and interacting with the user.

The connected/disconnected Portlet is preferably a Java technology based web component, managed by a Portlet container. Portlets are used as pluggable user interfaces components that provide a presentation layer to information systems. A Portlet is frequently programmed according to the Model-View-Controller (MVC)-pattern. FIG. 8 shows an example how this pattern can be implemented. The controller receives all incoming requests and controls their execution. The model is responsible for application data and transactions that can be associated with it; it encapsulates the business logic. A view is responsible for displaying data. To execute a request, the controller accesses the model and display views as required. To support disconnection there need to be an additional component, the disconnected controller that is restricted to the functionality provided by the disconnect Portal.

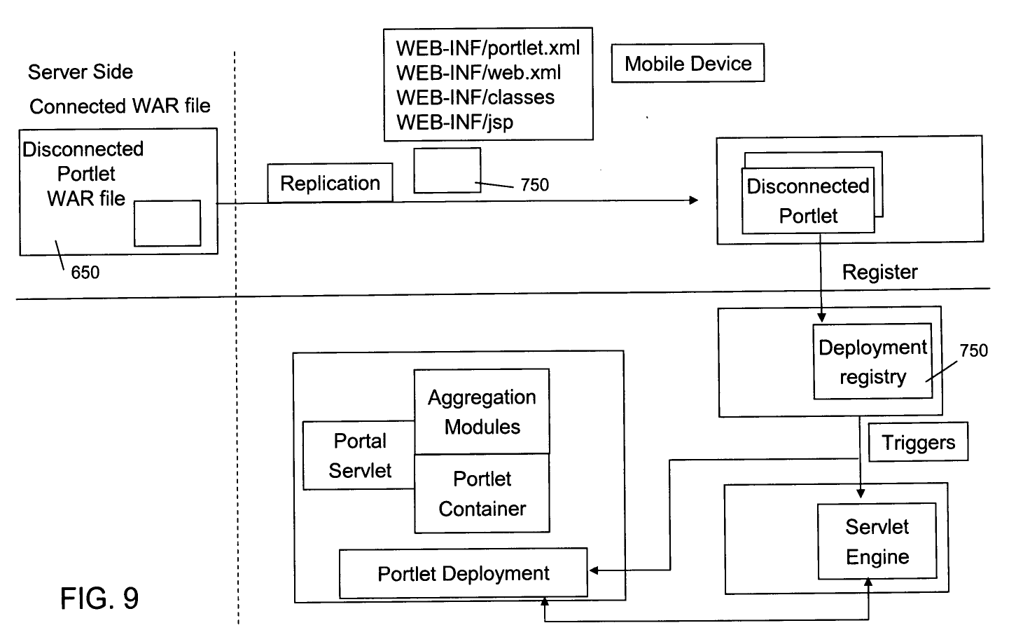

FIG. 9 shows how the disconnected Portlets located at the server side are packaged on the Portal server side, sent down to the Mobile Device and deployed on the disconnected Portal located at the Mobile Device side. If a user decides to go disconnected he may for example press the button “go disconnected” displayed by the disconnection Portlet.

The Migration Manager packages the disconnected Portlets selected by the user, the Mobile Device specific content topology created by the Topology Manager, as well as the data to be rendered by the disconnected Portlets 650. The packaged data may be sent to the Mobile Device as follows:
the Mobile Device specific content topology to enable the disconnected Portal to aggregate the page is sent as XML file 700,
the disconnected Portlets bundled as Portlet applications in WAR (web archive) files 700,
the data to be rendered by the disconnected Portlet 700.

These data may be transmitted using the synchronization protocol SyncML.

At the Mobile Device side the Deployment Registry receives and extracts theses files 750. Meta data which describes the disconnected Portlet are stored in the database. This applies accordingly to the data to be rendered by the disconnected Portlets and the Mobile Device specific content topology. The code of the disconnected Portlet will be stored in the Mobile Device File system.

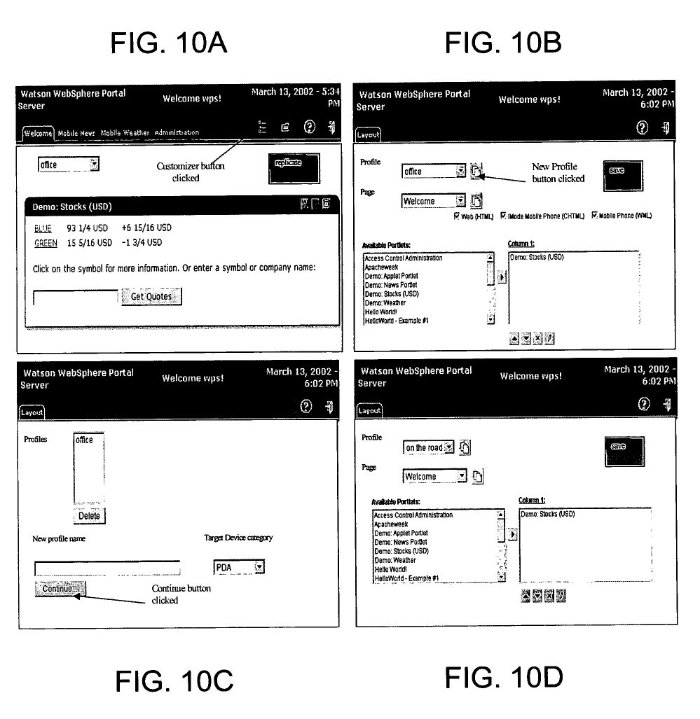

FIG. 10 A-D shows the screens to create a new disconnected user profile.

The disconnected user profile is created by a graphical user interface which comprises the profile name, the target Mobile Device and the Portlets to be used by the disconnected Portal. All data associated with that profile are transferred to the target Mobile Device for operations in disconnected mode. So a user should group in a profile all the Portlets that he wants to have available in disconnected mode. Then he should replicate the profile to trigger components to be sent to the target Mobile Device. The action of replication results in different things depending on the state of the server and Mobile Device. Indeed, the first time a user replicates a profile from the network Portal server, Portlet code, Portal data and Portlet data need to be transferred to the Mobile Device. Portlet code may include the controller code, the beans, the precompiled JSPs. The Portal data includes the Mobile Device specific content topology for the profile so that the Mobile Device aggregator knows how to render the profile, and the deployment descriptor for the Portlets. Portlet data is the data that the Portlet needs to access during disconnection operations. Consecutive times where the user replicates from the network Portal server, the Portlet code and Portal data may not need to be transferred if the Mobile Device did not remove those components. In that case, only the Portlet data needs to be synchronized with the Mobile Device. Similarly, when the user replicates from the mobile Portal server on the Mobile Device, the Portlet data needs to be synchronized with the server side Portlet data. In spite of this diversity of handling, the user only needs to be aware of the necessity to replicate the profile to make sure the Mobile Device contains the freshest data. In the case where the profile has already been replicated, the user may want to replicate only a subset of the Portlets in the profile. This could be useful for example when the user is connected through a slow network connection.

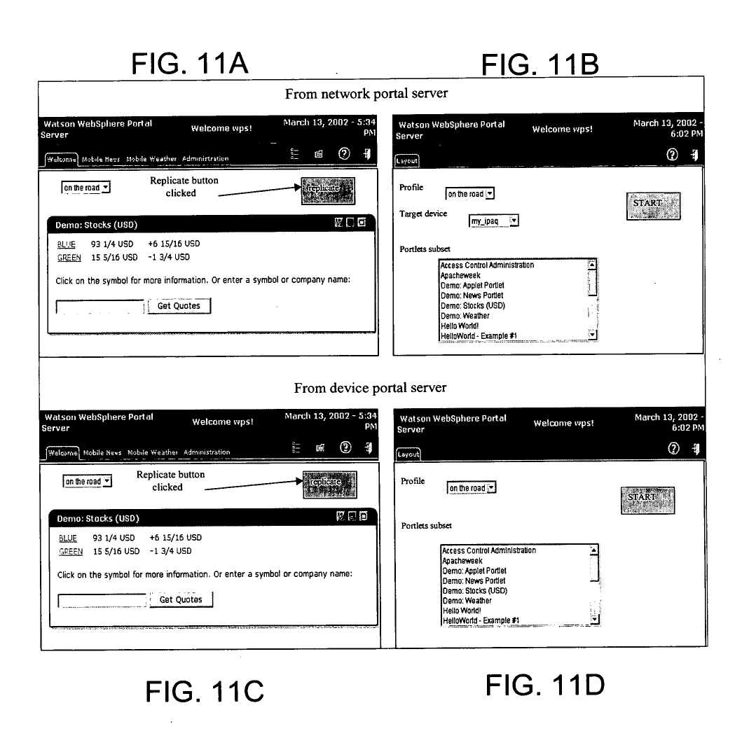

FIG. 11 A-D depicts the steps the user needs to take to switch between connected and disconnected mode. The replicate button and the menu listing the profiles are displayed by the disconnection Portlet (top left and bottom left corner). The disconnection Portlet has to be added by default to all Portal pages. It gets the list of profiles from the Portal Database. When the user clicks the replicate button, the disconnection Portlet gets the list of Portlets in this profile and presents a user interface that allows the user to select which of these Portlet he wants to replicate (FIG. 10 B/D). In addition to that, in the case of replication from the network Portal server, the disconnection Portlet should show the user a selection of devices that can be target for disconnection (FIG. 10 B). Once the user is ready, he clicks the start button to do the replication (FIG. 10 A). As mentioned earlier, the steps taken by the disconnection Portlet to do the replication depend of the state of Mobile Device and server. It could be preparing the whole Portlet code or just synchronizing the data used by Portlets.

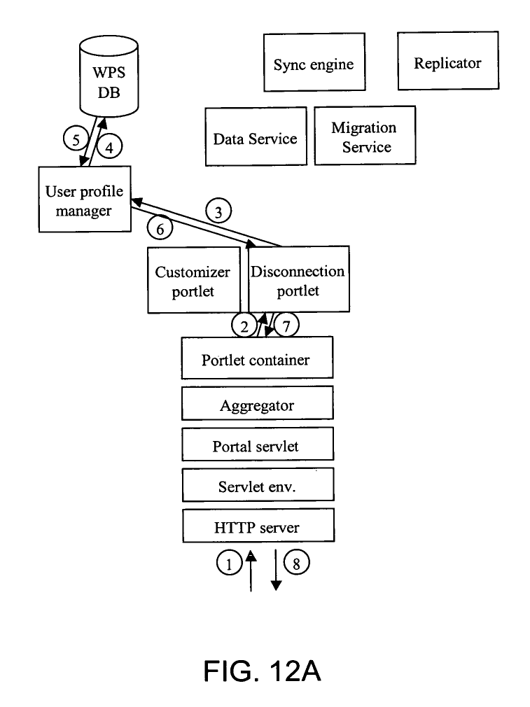

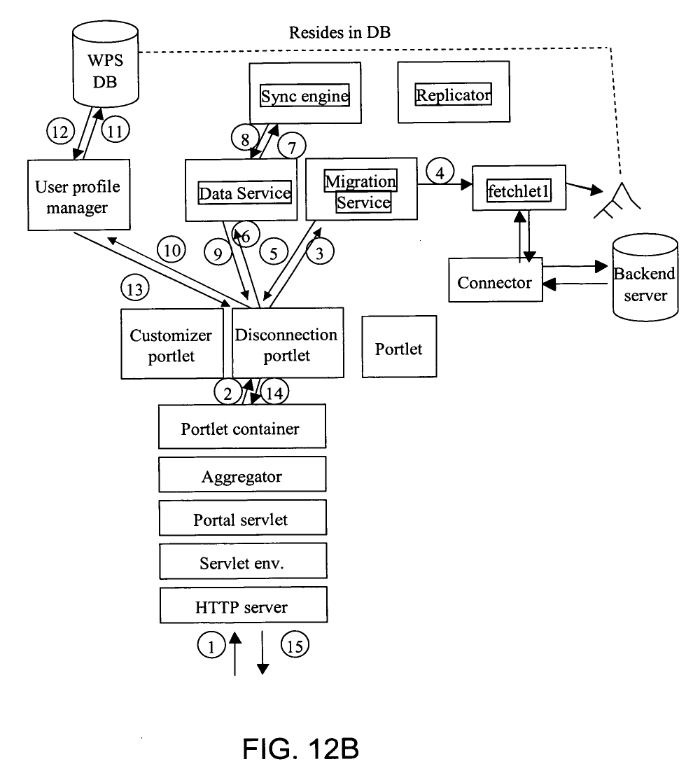

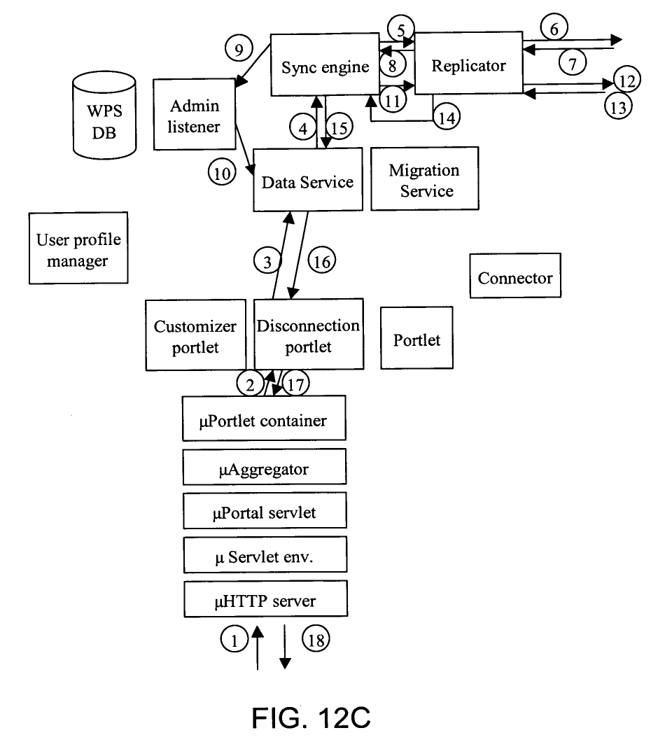

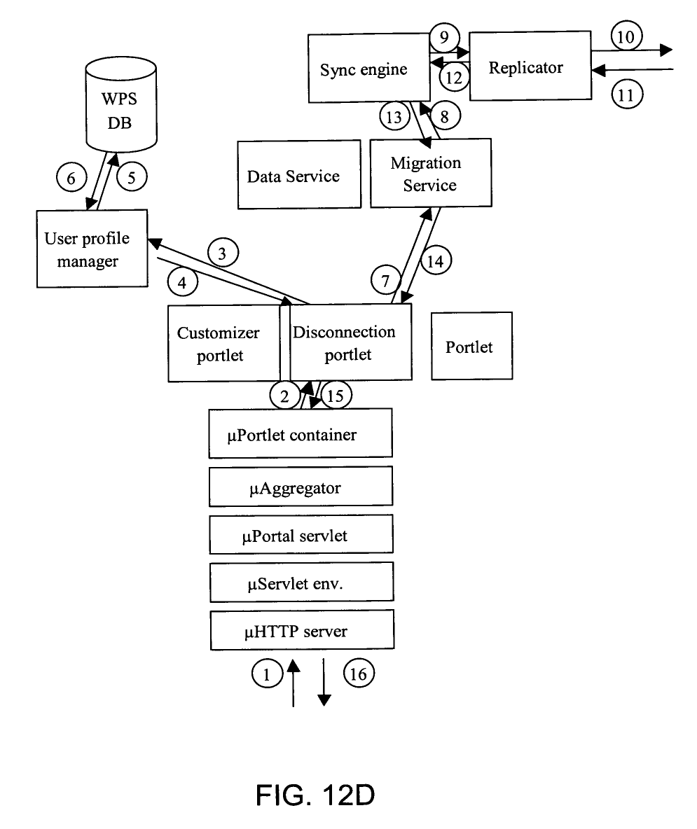

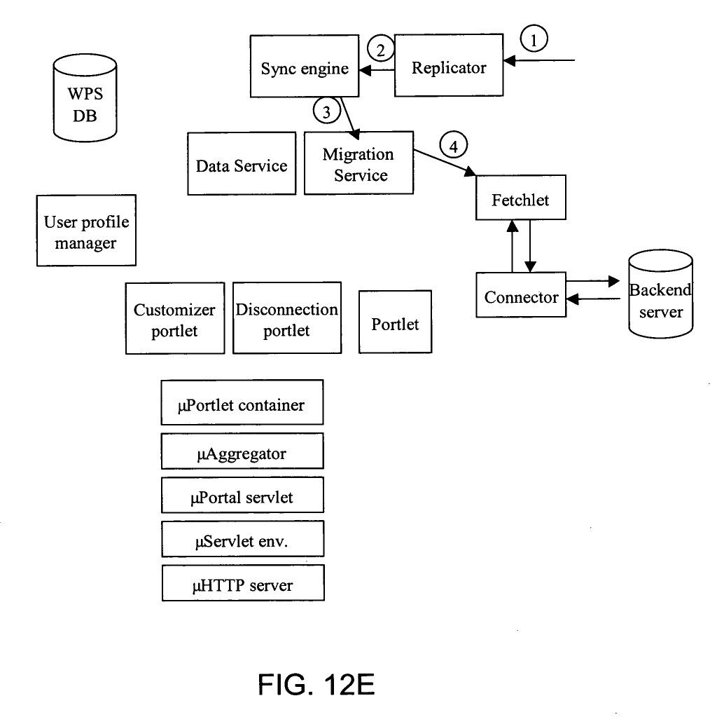

FIG. 12 A-E shows a preferred embodiment of the replication process as used by the present invention.

Replication from Server Side:

At replication from the connected view, several components need to collaborate to perform the replication.

FIG. 12 A shows the flow occurring in the first step of the replication when the infrastructure finds the list of Portlets in the profile and the possible target Mobile Device.

When the user clicks the replicate button, an HTTP request is sent to the Portal server (1). The request contains the name of the profile currently in use by the Mobile Device. The Portal servlets recognizes this request as being for the disconnection Portlet (2). The disconnection Portlet queries the user profile manager (3) to obtain the list of Portlets in that profile and the list of possible target Mobile Devices the user can replicate onto. The user profile manager gets that information from the WPS Database (4). With the information, the disconnection Portlet builds the graphical user interface that allows the user to potentially choose a subset of the Portlets to replicate and a menu of target Mobile Device. The next step is to do the actual replication of data when the user clicks the start button. This is shown in the following FIG. 12 B/C. FIG. 12 B shows the step at the server side. The Portal receives a request for the disconnection Portlet with the scope of the replication and the target device as parameters (1). The scope of the replication indicates if whole profile should be replicated or only selective Portlets out of the profile. This may be useful when the connectivity is slow. Using that information, the disconnection Portlet requests the migration service to start the hoarding phase for each of the requested Portlets (3). For each Portlet, the migration service needs to invoke the fetchlet that the Portlet registered (4). This results in the fetchlet fetching information from backend servers and updating the data models provided by the Portlet. The disconnection Portlet requests the creation of an “administrative” data model to the data service (6). The data service forwards the request to the sync engine that takes care of creating a new data instance (7). The disconnection Portlet puts in this data model the list of Portlet ids. For each Portlet, it adds the list of associated data models ids; it requests the PortletData object from the Portal DB. It also requests the war file for the profile and the profile description from the user profile manager (10). Once this data model is created, the disconnection Portlet creates a redirect URL pointing at the local WPS server on the target device and with the parameter id of the administrative data model it just created (15).

FIG. 12 C shows the steps at the Mobile Device side upon reception of the redirect URL (1). The Portal servlets directs this request to the disconnection Portlet (2). The disconnection Portlet isolates the id of the administrative data model that should be replicated and uses the data service to trigger the replication of this model (3). The data service forwards the request to the sync engine (4). The sync engine uses the replicator to get the data model from the server side (5). The admin listener has registered with the sync engine so that when an administrative data model is received, it gets invoked. So upon reception of the administrative data model, the sync engine invokes the admin listener (9). The admin listener parses the data model, deploys the Portlets included in the war file on the mobile Portal along with their corresponding Portlet Data objects. It stores the profile topology and the profile description in the Mobile Device Database. The admin listener then triggers the replication of the models associated with the Portlets using the unique id included in the data model (11). This results in the sync engine requesting the replicator to get the appropriate models from the server side (12).

Replication from the Mobile Device Side:

In the case of a replication from the Mobile Device side, some of the steps just described are not needed. FIG. 12 D/E illustrate the steps.

To provide the ability to choose a subset of the Portlets to replicate, the steps presented in FIG. 11 be run first. If the user chooses to replicate the whole profile, the steps in FIG. 12 D are performed.

FIG. 12 D shows the flow in the infrastructure in the Mobile Device side: the click of the start button generates a HTTP request asking for replication on a profile (1). The Portal servlets directs the request to the disconnection Portlet (2) which gets from the user profile manager the list of Portlets in the profile (3). It then requests the migration service to replicate the models associated with each of the Portlet (7). The migration service forwards the request to the sync engine (8) that interacts with the replicator to complete the replication (9).

FIG. 12 E shows the steps at the server side when the Mobile Device triggers replication. The replicator receives a synchronization message (1). It invokes the sync engine (2) which is in charge of merging the changes made at the Mobile Device with the data model at the server side. To reflect those changes in the backend servers, the sync engine invokes the migration service that knows which fetchlet each Portlet registered (3). The migration service invokes the fetchlet that interacts with the backend servers to synchronize the data.

1. A server system having a Portal server and a communication link to Mobile Devices having a disconnected Portal, a Deployment Registry, and a Synchronization Engine, wherein said Portal server is characterized by the further components:
a Topology Manager (40) which provides means to automatically create a Mobile Device specific content topology for a disconnected Portal at said Server system,
a Dynamic Information Manager (30) which provides means to access dynamic information and to provide said dynamic information to said Topology Manager in order to adapt an existing user-defined connected content topology to a Mobile Device specific environment resulting in a Mobile Device specific content topology,
a Migration Manager (50) which provides means to package said Mobile Device specific content topology for said disconnected Mobile Portal including disconnected Portlet applications assigned to said Device specific content topology, and the Portlet data to be rendered by said disconnected Portlet applications,
a Synchronization Engine (80) to synchronize data between said server and said Mobile Device.

2. The server according to claim 1, wherein said Topology Manager (40) has access to user-disconnected profile Database, wherein each user-disconnected profile is defined by a user profile identification, a selected target Mobile Device, selected disconnected Portlet applications to be used by the disconnected target Mobile Portal, and the associated dynamic information.

3. The server according to claim 2, wherein said user-defined disconnected profile is created by user profile manager (29).

4. The server according to 2, wherein said user profile manager (29) provides a graphical user interface to support the selection of the available Portlets.

5. The server according to claim 1, wherein said Dynamic Information Manager (30) has access to a Database which stores the dynamic information (33).

6. The server according to claim 5, wherein said dynamic information includes communication link capabilities, Mobile Device capabilities, and Mobile Device location information.

7. The server according to claim 4, wherein said Topology Manager (40) creates a Mobile Device specific content topology at the server side by using the information defined by said user-defined disconnected profile.

8. Server according to claim 7, wherein information specified by said user-defined disconnected profile is sent to said Mobile Device (1) in a single file.

9. The server according to claim 8, wherein said Migration Manager (50) creates a XML file including said Mobile Device specific content topology, a WAR file for said disconnected Portlet applications with their deployment descriptors, and said Portlet data to be rendered by said disconnected Portlets.

10. (canceled)

11. The server according to claim 1, further comprising a disconnection Portlet (27) allowing the Mobile Device to switch from the connected mode into the disconnected mode.

12. (canceled)

13. A mobile Device having a communication link to a server system having a Topology Manager (40) which provides means to create Mobile Device specific content topology for a disconnected Mobile Portal at said Server system side, Dynamic Information Manager (30) which provides means to access dynamic information and to provide said dynamic information to said Topology Manager in order to adapt an existing user-defined connected content topology to a resulting Mobile Device specific content topology for a target Mobile Device specific environment, a Migration Manager (50) which provides means to package said Mobile Device specific content topology for said disconnected Mobile Portal including its disconnected Portlet applications assigned to said Mobile Device specific content topology, and the Portlet data to be rendered by said disconnected Portlet applications (user disconnection profile), a Synchronization Engine (80) to synchronize the data between said server and said Mobile Device, wherein said Mobile Device (1) is characterized by the further components:
a disconnected Portal framework (70),
disconnected Portlets (5) being provided by said Portal server,
a Deployment Registry (90) for deploying and registering the disconnected Portlets being provided by said Portal server,
a Synchronization Engine (76) for receiving the disconnected Portlet applications and Mobile Device specific content topology and for sending and receiving the data to be rendered by said Portlet applications.

14. The mobile Device according to claim 13, further comprising
a Database (31) for storing the Mobile Device specific content topology and the data to be rendered by said Portlet applications,
a Migration Manager (82) for keeping track of the changes between said Mobile Device and said Server System and triggering the synchronization.

15. The mobile Device according to claim 14, further comprising a disconnection Portlet (72) allowing a switch from the disconnected mode into the connected mode.

16. The mobile Device according to claim 13, wherein said disconnected Portal framework 70 comprises a disconnected Portal servlet, an embedded aggregator, and an embedded Portlet container, wherein all components are adapted to the Mobile Device specific environment.

17. (canceled)

18. Method for creating a Mobile Device specific content topology at a Portal Server, comprising the steps of:
initiating a switch at the server side from a connected to a disconnected mode between said Portal Server and said Mobile Device,
selecting available disconnected Portlet applications to be replicated to said Mobile Device,
creating a Mobile Device specific content topology based on an existing user-defined connected content topology including said selected disconnected Portlet applications and dynamic information about channel capabilities, said Mobile Device capabilities, and location information of said target Mobile Device,
packaging said Mobile Device specific content topology including said selected disconnected Portlet applications assigned to it and said data to be rendered by selected Portlet application,
transferring said Mobile Device specific content topology including said selected disconnected Portlet applications assigned to it, and said data to be rendered by said selected Portlet application to said Mobile Device.

19. Method according to claim 18, wherein said disconnected mode is accomplished by a disconnection Portlet.

20. Method according to claim 19, wherein said disconnection Portlet is added by default to all Portal pages.

21. Method according to claim 20, said disconnection Portlet presents a graphical user interface allowing a user to select the Portlet application to be replicated and the target Mobile Device.

22. Method according to claim 19, wherein said selecting step further comprises of:
determining the availability of said selected disconnected Portlet applications for the Mobile Device,
removing non-available Portlet applications from said existing user-defined connected content topology.

23. (canceled)

24. Method according to claim 19, wherein each change of the data belonging to the Mobile Device specific content topology stored at the server side or at the Mobile Device side is synchronized during the connected mode.

25. (canceled)
